(19) United States
(12) Patent Application Publication
(10) Pub. No.: US 2023/0297410 A1
(43) Pub. Date: Sep. 21, 2023

(54) DEVICE VIRTUALIZATION IN A CONFIDENTIAL COMPUTING ENVIRONMENT

(71) Applicant: Intel Corporation, Santa Clara, CA (US)

(72) Inventors: Kapil SOOD, Portland, OR (US); Scott P. DUBAL, Oregon City, OR (US); Patrick CONNOR, Beaverton, OR (US); James R. HEARN, Hillsboro, OR (US)

(21) Appl. No.: 18/200,458

(22) Filed: May 22, 2023

(51) Int. Cl. G06F 9/455

(52) U.S. Cl. CPC G06F 9/45558; G06F 2009/45587; G06F 2009/45579

(57) ABSTRACT

Examples described herein relate to a trusted and secure emulated device. The emulated device can be assigned to a service based on attestation of a hardware platform of the emulated device, assignment of the emulated device to a trust domain, and attestation of a device configuration associated with the emulated device.

### BACKGROUND

The Peripheral Component Interconnect Special Interest Group (PCI-SIG) Integrity and Data Encryption (IDE) specification (Dec. 2, 2020) requires devices connecting to a central processing unit (CPU), system on chip (SoC), network interface device, or other device to provide: (1) Trusted Identity (e.g., in the form of a private key), (2) end point authentication (e.g., to ensure the devices and its firmware are from a trusted source), (3) key establishment for the Peripheral Component Interconnect express (PCIe) link communication session (e.g., to establish a new sets of keys), and (4) encryption and integrity (e.g., to protect data shared between the device and the SoC, CPU, or network interface device).

### BRIEF DESCRIPTION OF THE DRAWINGS

FIG. 1 depicts an example system.

FIGS. 2A and 2B depict example systems.

FIG. 3 depicts an example of register locking.

FIG. 4 depicts an example of end-to-end tenant attestation of an emulated SEP device in a trust domain (TD).

FIG. 5 depicts an example process to assign an emulated device.

FIG. 6 depicts an example process.

FIG. 7 depicts an example system.

FIG. 8 depicts an example system.

### DETAILED DESCRIPTION

In some platforms, a network interface device can include a smart endpoint (SEP) that can provide an intermediary device between a server and circuitry in the network interface device. Applications executing on the server can communicate with the SEP as though communicating with the network interface device and the SEP can provide applications with access to circuitry of the network interface device. An SEP can provide applications with access to emulated PCIe devices via one or more emulated SEPs.

In some cases, the SEP, or an emulated SEP, can be used for a man-in-the-middle (MITM) attack by spoofing a PCIe device and accessing data or commands intended for that spoofed PCIe device or the spoofed PCIe device provides malicious data or commands to a tenant's virtual machine (VM) or container. An SEP can act as a MITM where a tenant is not aware of the use of an SEP as an intermediary or passes data to the SEP without encryption. A masquerading attack can occur where a virtual machine (VM) or container provides data or retrieves data from the emulated device that is not an authorized emulated device. For example, identity theft can occur that can lead to loss of data and identity data, including user and subscriber data.

At least to attempt to reduce likelihood of successful MITM attacks, a trusted SEP, or other circuitry or firmware, can be attested prior to assigning an emulated device to a trust domain. The trusted SEP or other circuitry or firmware can form an emulated device and can provide access to the emulated device via a device interface to an entity. The SEP or other circuitry or firmware can include technologies to communicate with a particular emulated device with a unique identifier attested using signed keys so that the unique identifier can be validated and attested prior to use for communication with the emulated device and communications to and from the emulated device. The SEP or other circuitry or firmware can provide trusted and secure access to the emulated device to a virtual execution environment.

In some examples, the emulated device has an associated cryptographic domain to exclude access from unauthorized accesses to the emulated device and associated data. The entity and emulated device can operate as part of confidential computing cluster and data can be encrypted and decrypted using keys available for use in a particular confidential computing cluster. Examples can extend confidential computing technologies to cover server systems, SEP, and back-end devices. An entity can include a virtual machine, container, application, process, service, micro-service, or others. An emulated device can represent an assignment of shared or unshared software and hardware resources. Based on successful attestation of the emulated SEP device, a tenant can be assigned use of the SEP emulated device and can access the emulated SEP device.

Accordingly, prior to assignment of the emulated device to a virtualized execution environment, various examples provide a trusted emulated device (e.g., trusted emulated SEP device) based on one or more of: attestation of hardware underlying the emulated device, assignment of the emulated device to a trust domain, attestation of a device configuration associated with the emulated device, and attestation of and authentication of an emulated device identifier.

Accordingly, an entity can avoid communicating with an emulated device if an identifier of the emulated device does not match an approved emulated device identifier. In addition, despite the entity communicating with a spoofed emulated device, shared or received data can be protected so that the spoofed device is not able to access from the entity. In addition, with use of an SEP or emulated devices, a tenant can address regulatory requirements for protecting customer data at rest, in motion between memory devices, or while being processed.

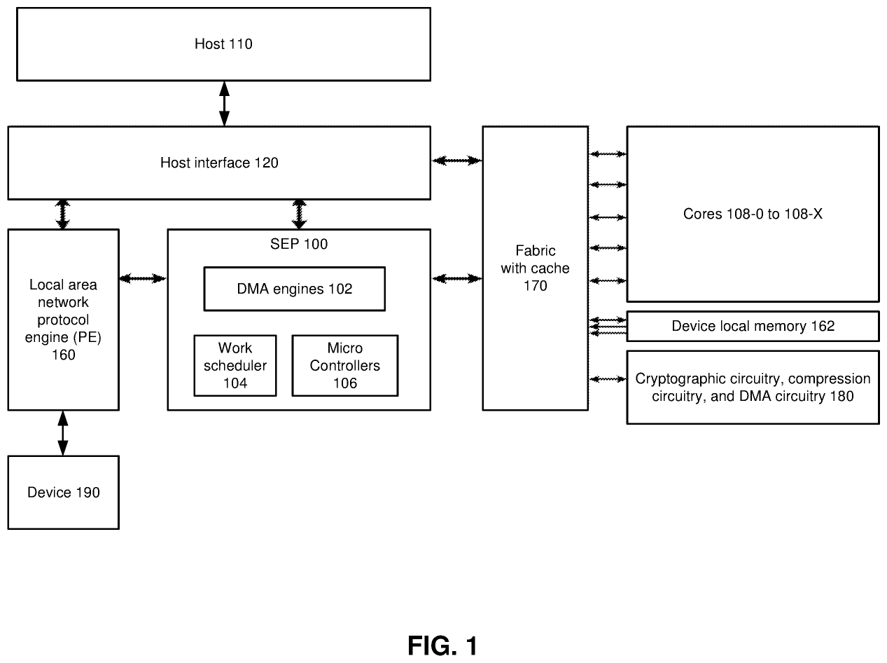

FIG. 1 depicts an example system. Smart endpoint (SEP) or endpoint circuitry 100 can provide an intermediary device between a host system (e.g., server) 110 and protocol engine 160. SEP 100 can utilize work scheduler 104 to schedule transmission of commands and communications received from host 110 via host interface 120 to protocol engine 160 or via fabric 170 to cores 108-0 to 108-X, where X≥1. In some examples, SEP 100 can utilize microcontroller 106 to perform operations of SEP 100 such as a security agent or security controller, as described herein. SEP 100 can utilize DMA engine 102 to copy data from or to host 110.

Protocol engine 160 can provide commands and communications between an application and operating system (OS), executed by processors on host 110, and device 190 in accordance with one or more applicable application program interfaces (APIs) or protocols (e.g., Non-Volatile Memory Express (NVMe) or others). In some examples, protocol engine 160 can be associated with device 190 (e.g., a network interface device, storage controller, storage device (e.g., NVMe drive), memory pool controller, graphics processing unit, cryptographic processor, or other device).

SEP 100 can emulate a specific Peripheral Component Interconnect express (PCIe) device or other interface for input/output (I/O) virtualization. For example, SEP 100 can emulate a PCIe device front-end with one or more of the following performing back-end operations: local area network (LAN) protocol engine (PE) 160, device 190, or cores 108-0 to 108-X. For example, SEP 100 can provide access to one or more virtual or emulated instances of a SEP and its back-end per customer's parameters and system configuration. For example, in accordance with a customer's parameters and system configurations, based on shared or exclusively allocated software and/or hardware, an emulated instance of SEP can include an instance of one or more of: storage devices, specific software and/or hardware accelerators, networking interfaces, or other devices. Processing engine 160 and/or firmware executing in SEP 100 can expose registers of emulated SEP device for access by applications executed by host 110. Emulated device instances can utilize shared infrastructure, circuitry, and/or hardware resources (e.g., memory 162, storage, buffers, other direct memory access (DMA) engines 102, work scheduler 104, microcontrollers 106, fabric 170, cryptographic circuitry, compression circuitry, and DMA circuitry 180, accelerators (e.g., field programmable gate arrays (FPGAs)), storage controllers, and others). SEP 100 can be used in Edge and Cloud-to-Edge usages where Communications services providers (CoSPs) and cloud service providers (CSPs) can create emulated devices to perform tenant workloads (WLs).

In addition, instances of emulated devices can co-exist, can be stopped and restarted as new devices, can be paused and resumed as the same device or platform or different device or platform. For example, code, data, and context state for an emulated device can be stored in a TD associated with a tenant and the code, data, and context state can continue to be stored based on the TD associated with the tenant going offline and can resume access to the emulated device state after the TD is re-scheduled for use by an operating system (OS) or hypervisor. A customer may access one or more of the emulated devices at the same time or in staggered usage patterns.

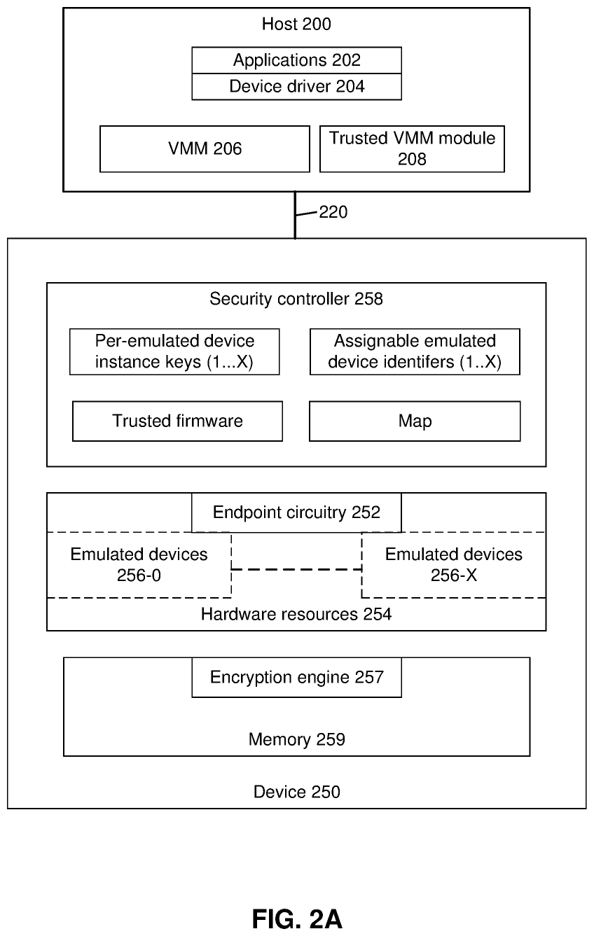

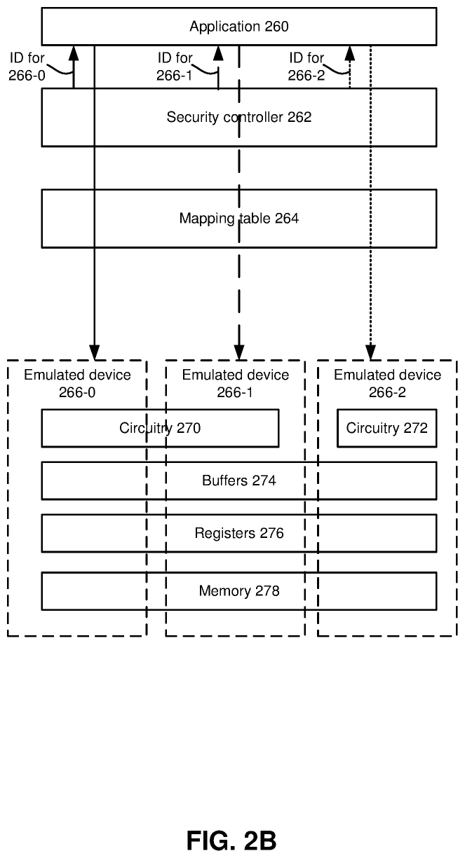

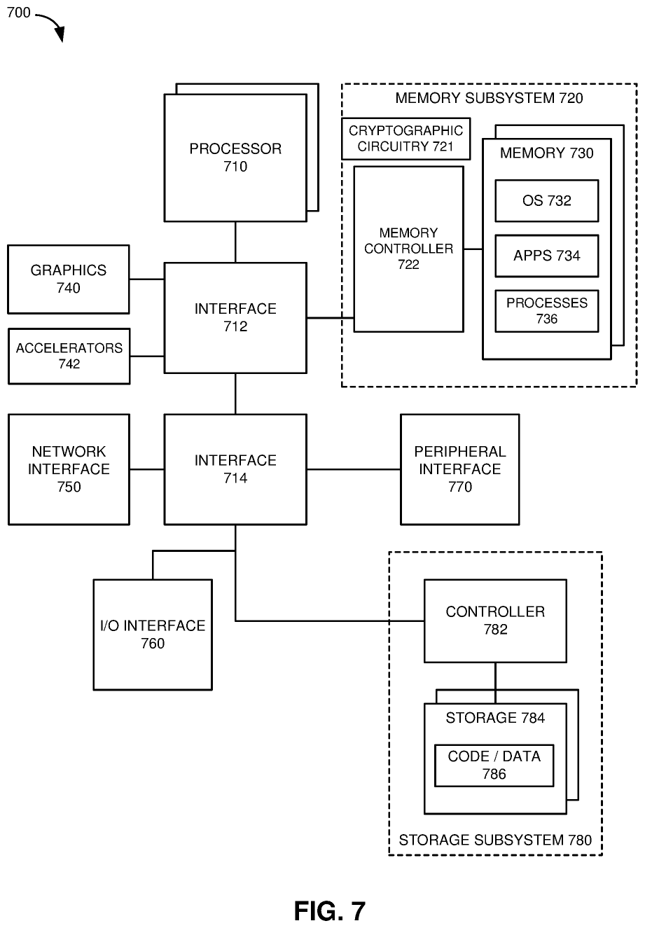

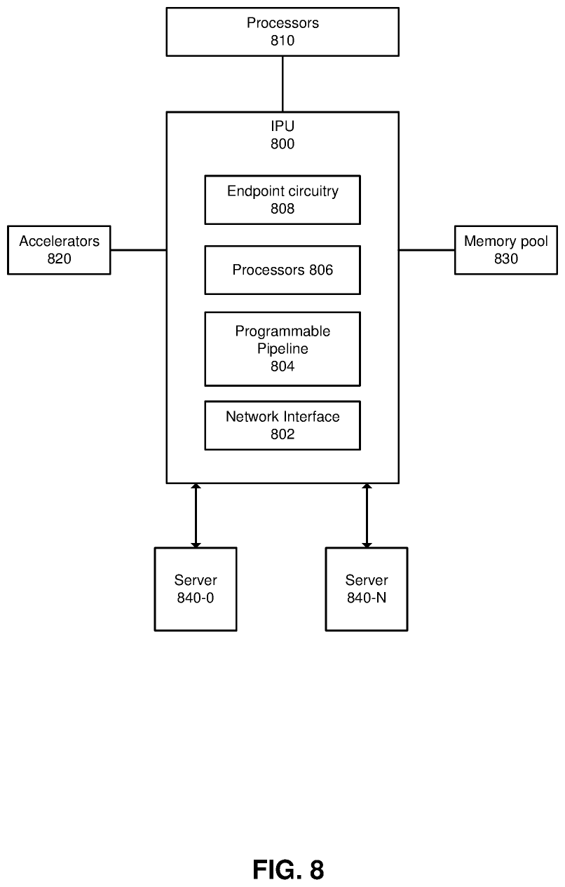

FIG. 2A depicts an example system. Host 200 can include one or more processors, one or more memory devices, one or more device interfaces, as well as other circuitry and software described at least with respect to one or more of FIG. 7 or 8. Processors of host 100 can execute software such as applications 202 (e.g., services, microservices, virtual machine (VMs), microVMs, containers, processes, threads, or other virtualized execution environments), operating system (OS), and one or more device drivers 204. For example, applications 202 executing on host 200 can communicate with device 250 using device driver 204 to receive or transmit packet traffic using device 250 and/or transmit commands to device 250 or receive commands from device 250. Virtual machine manager (VMM) 206 and trusted VMM 208 can provide virtualized access to emulated devices, as described herein.

Host 200 can communicate with device 250 using system interface 220. System interface 220 can include communication circuitry such as a bus or other conductive circuitry.

Device 250 can include at least one or more security controllers 258, endpoint circuitry 252 such as a SEP, and hardware resources 254. Endpoint circuitry 252 can provide access to one or more emulated instances of a SEP as emulated devices 256-0 to 256-X. For example, via system interface 220, emulated devices 256-0 to 256-X can be accessible via PCIe, Compute Express Link (CXL), Universal Chiplet Interconnect Express (UCIe), Single Root I/O Virtualization (SR-IOV), or Scalable Input/Output (I/O) Virtualization (S-IOV) virtual device.

Trusted firmware executed on device 250 or controller 258 can create instances of the emulated endpoint devices by providing particular register accesses and composition of hardware to emulated device instances. For example, emulated devices 256-0 to 256-X can represent a composition of emulated endpoint circuitry 252 and/or other hardware resources 254. Hardware resources 254 can include one or more of: firmware, software, circuitry, cache, memory, storage, a microprocessor, processor, accelerator, field programmable gate array (FPGA), application specific integrated circuit (ASIC), network interface device, storage controller, memory pool controller, graphics processing unit, cryptographic processor, or other software or devices described at least with respect to one or more of FIG. 7 or 8.

For example, an emulated device can implement a virtual storage device in virtio mode to enable virtual storage devices, the emulated device can handle virtio queues, and a Storage Performance Development Kit (SPDK) based back-end service running on a compute complex (e.g., cores 108-0 to 108-X) can perform storage operations. Reference to virtio devices could include either virtio-net or virtio-blk.

Security controller 258 can provide platform or end-to-end (E2E) security for multi-tenant data center. Security controller 252 can provide trusted software, firmware, and hardware that are signed and verified upon boot and prior to creation of an emulated device. Trusted Computing Group (TCG) Device Identifier Composition Engine (DICE) standards (e.g., DICE Attestation Architecture Version 1.00 (2020) and earlier versions, revisions, and variations thereof) can be utilized to sign and verify software, firmware, and hardware. In addition, security controller 252 can provide a root of trust for emulated devices 256-0 to 256-X, where X≥1, as well as device 250, endpoint circuitry 252, and/or hardware resources 254. Security controller 252 can provide keys for emulated devices and attestation and signing of emulated device identifiers. Keys can be used by applications and devices assigned to a particular tenant.

Security controller 258 can assign a unique identifier to an emulated endpoint (e.g., SEP) device with a specific configuration. In some examples, a trusted firmware executed by security controller 258 can generate an emulated device identifier for each emulated SEP based on public and private pairs. If multiple emulated devices are created, then each of the multiple emulated device can be assigned its own unique identifier despite use by one or multiple tenants. Security controller 258 can track an emulated device instance and its identifier and store encrypted emulated device instance and identifier in encrypted storage. For example, an emulated device identifier can be based on a unique hash derived from a public and private key pair (e.g., Rivest-Shamir-Adleman (RSA), Elliptic-curve cryptography (ECC), or others), or blockchain-based identities.

For example, keys for one or more of the following can be signed by authorized parties or devices (e.g., security controller 252 or attestation server): firmware (e.g., Security-Version Number (SVN)), endpoint circuitry 252, software, and hardware resources 254 (e.g., circuitry, accelerator, memory devices, storage devices, or others). An attestation root key can be used for signing a hash value obtained by concatenating the first boot firmware or software and subsequent firmware or software images that are in the Trusted Compute Base (TCB) of the SEP emulated devices.

In some examples, per-emulated device keys can be created by a secure and trusted firmware executed by trusted network interface device 250. In some examples, security controller 258 can create keys with handles for the firmware to assign unique keys to created emulated devices. Emulated devices can be assigned a unique key and hence, a unique identity. For example, an emulated device identity can be a hash of a concatenation of: public key portion, configuration and initial emulated device firmware identifiers, and signed by security controller 258 or trusted firmware of device 250.

Security controller 258 and/or trusted firmware executed by network interface device 250 can dynamically generate and assign keys to physical function (PF) or endpoint circuitry 252. For Trusted Domain Extensions (TDX) connected physical devices, the keys can be securely provisioned during a manufacturing process of security controller 258 and/or device 250.

Attestation and authentication of device 250 can occur as part of a PCIe Link Security key protocol (e.g., PCI-SIG IDE standard), which can authenticate device 250 and create common pair-wise unique keys for encryption for communications between host 200 and device 250. A tenant can authenticate device 250 through its trust domain (TD), and device 250 can be packaged as part of an attestation quote that the TD receives from an emulated device, which is signed by an attestation root key of device 250.

In some examples, emulated devices can independently operate in cryptographically isolated trust domains. A cryptographic domain can be associated with an attested identifier and keys assigned for use in a particular domain. Security controller 252 can provide cryptographic isolation of at least one of emulated devices 256-0 to 256-X. For example, shared resources (e.g., buffers, memory 259, state machine circuitry, accelerators, etc.) can have access control and data access separation, whereby shared queues, state machines, are either dedicated to an emulated device for exclusive use and/or are identified and accessed using an emulated device identifier (ID) and data access protection schemes are utilized (e.g., data encryption and decryption of data at rest or while in transit). An attested platform (e.g., device 250, firmware, or controller 258) can provide a trusted assignment of an emulated device to a trust domain.

A trust domain, confidential computing environment, or secure enclave can be created using one or more of: total memory encryption (TME), multi-key total memory encryption (MKTME), Trusted Domain Extensions (TDX), Double Data Rate (DDR) encryption, function as a service (FaaS) container encryption or an enclave/TD (trust domain), Intel® SGX, Intel® TDX, AMD Memory Encryption Technology, AMD Secure Memory Encryption (SME) and Secure Encrypted Virtualization (SEV), AMD Secure Encrypted Virtualization-Secure Nested Paging (AMD SEV-SNP), ARM® TrustZone®, ARM® Realms and Confidential Compute, Apple Secure Enclave Processor, Qualcomm® Trusted Execution Environment, RISC-V Trusted Execution Environment (TEE), Distributed Management Task Force (DMTF) Security Protocol and Data Model (SPDM) specification, virtualization-based isolation such as Intel VTd and AMD-v, or others.

A trusted authority can attest to whether an identifier is valid. An attestation quote can be sent to the CSP/CoSP trusted attestation server to verify the signed quote. Alternatively, the signed quote could be sent to the tenant's trusted virtual machine (VM) (e.g., Trust Domain Extensions (TDX) VM), which can authenticate the quote.

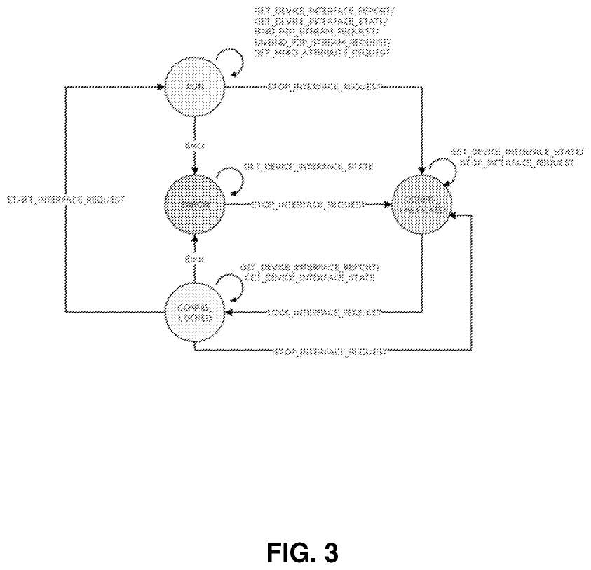

Device 250 can create multiple emulated end point devices 256-0 to 256-X. However, emulated endpoint devices 256-0 to 256-X are not exposed to applications 202 until emulated endpoint devices are assigned to a TD through a trusted host module (e.g., as a TDX Connect Module), successful attestation of the emulated device, and the end point device configuration is locked (e.g., FIG. 3). Based on assignment of the emulated device to a trust domain and a successful attestation of the emulated device, the tenant can allow the use of the SEP emulated devices by one or more of applications 202. For example, trusted firmware can expose the emulated device instance as a device to host 200. A virtual machine manager (VMM) (e.g., VMM 206 or 208) executing on host 200 can virtualize emulated device instances to provide access to emulated device.

Data access protection schemes to protect data at rest or while in transit can apply to data stored in local memory or external memory or storage based on a unique key for an emulated device. Security controller 258 can create an emulated device keys and access to the keys can be limited to security controller 258. For example, emulated device keys can be built and managed in a similar manner as that of Intel® Multi-Key Total Memory Encryption (MK-TME).

Security controller 258 can access a virtualization map to map transactions from and to specific host applications 202 to intended emulated device using mapping table (e.g., map) to administer security policies to access control (e.g., permit or deny incoming and outgoing transactions (e.g., memory-mapped I/O (MMIO), register reads or writes, DMA, etc.,) by the mapping table.

Encryption or decryption of data accessible to emulated devices can use, for example, total memory encryption (TME) and multi-key total memory encryption (MKTME) commercially available from Intel Corporation (as described in the Intel Architecture Memory Encryption Technologies Specification version 1.1 dated Dec. 17, 2017, earlier versions, revisions, and variations thereof), components that make up TME and MKTME, the manner in which TME and MKTME operate, and so forth. TME provides a scheme to encrypt data by memory interfaces whereby a memory controller encrypts the data flowing to the memory or decrypts data flowing from memory and provides plain text for internal consumption by the processor.

In some examples, TME is a technology that encrypts a device's entire memory or portion of a memory with a key. When enabled via basic I/O system (BIOS) (or Universal Extensible Firmware Interface (UEFI), or a boot loader) configuration, TME can provide for memory accessed by a processor on an external memory bus to be encrypted, including customer credentials, encryption keys, and other intellectual property (IP) or personal information. TME supports a variety of encryption algorithms and in one embodiment may use a National Institute of Standards and Technology (NIST) encryption standard for storage such as the advanced encryption system (AES) XTS algorithm with 128-bit keys, 256-bit keys, or other length keys. The encryption key used for memory encryption is generated using a hardened random number generator in the processor and is never exposed to software. Data in memory and on the external memory buses can be encrypted and is in plain text while inside the processor circuitry. This allows existing software to run unmodified while protecting memory using TME. There may be scenarios where it would be advantageous to not encrypt a portion of memory, so TME allows the BIOS (or UEFI or bootloader) to specify a physical address range of memory to remain unencrypted. The software running on a TME-capable system can access portions of memory that are not encrypted by TME.

In some embodiments, TME can support multiple encryption keys (Multi-Key TME (MKTME)) and provides the ability to specify the use of a specific key for a page of memory. This architecture allows either processor-generated keys or tenant-provided keys, giving full flexibility to customers. Processes can be cryptographically isolated from each other in memory with separate encryption keys which can be used in multi-tenant cloud environments. Processes can also be pooled to share an individual key, further extending scale and flexibility.

Trusted VMs/containers can rely on devices in multi-hosted virtualization models (e.g., VMware, Microsoft® Azure Cloud®, or others) where VMs can be paused and re-started and re-started VMs can continue using the paused SEP instances. If a previously instantiated emulated SEP device is restarted, emulated SEP device resumes operation with a same identity. Hence, SEP instances resume operation with their original identities.

In some examples, security controller 252 can perform operations of one or more of: Intel® Converged Security and Management Engine, Microsoft or Open Compute Project Cerberus, Amazon Nitro, or others.

FIG. 2B depicts an example system. For example, emulated device 266-0 and emulated device 266-0 can be allocated shared use of circuitry 270, buffers 274, registers 276, and memory 278. For example, emulated device 266-2 can be allocated exclusive use of circuitry 272 and shared use, with emulated devices 266-0 and 266-1, of buffers 274, registers 276, and memory 278. In some examples, security controller 262 can attest and verify hardware and software resources associated with emulated devices 266-0, 266-1, and 266-2. Based on attestation and verification of identifiers associated with emulated devices 266-0, 266-1, and 266-2, assignment of emulated devices 266-0, 266-1, and 266-2 to one or more trust domains, and locking of registers, security controller 262 can share the unique identifiers with applications 260 to access emulated devices 266-0, 266-1, and 266-2.

For example, security controller 262 can utilize mapping table 264 to administer security policies for incoming and outgoing transactions (e.g., MMIO, registers, DMA, etc.) to restrict communications. To access a particular emulated device, an application of applications 260 can provide the associated unique identifier with communications to an emulated device. Communications received from an emulated device can be associated with the unique identifier. If the unique identifier is not utilized or is different than assigned, communications are not permitted to proceed to an emulated device or applications 260.

FIG. 3 depicts an example of register locking. After authentication and attestation of an emulated SEP device, access to registers and MMIO associated with the emulated SEP device can be locked based on an assignable interface's security policy and security policy per the PCIe-SIG Trusted Execution Environments (TEE) Device Interface Security Protocol (TDISP) standard (2022). In some examples, instructions or data stored in the registers or accessed via MMIO can be encrypted using keys available to the requester (e.g., application) and emulated SEP device.

A device interface can be associated with configuration registers. Some configuration registers can be adjusted or managed by a TD or VM running in a TD. Some configuration registers can be adjusted or managed by VMM or TD module. MMIO reads/writes can be used as a doorbell between the VM and device to indicate readiness for data processing. For external devices, data copied between TD and interface can be encrypted and integrity protected. For communication between circuitry within a system on chip (SoC), data encryption can be optionally performed.

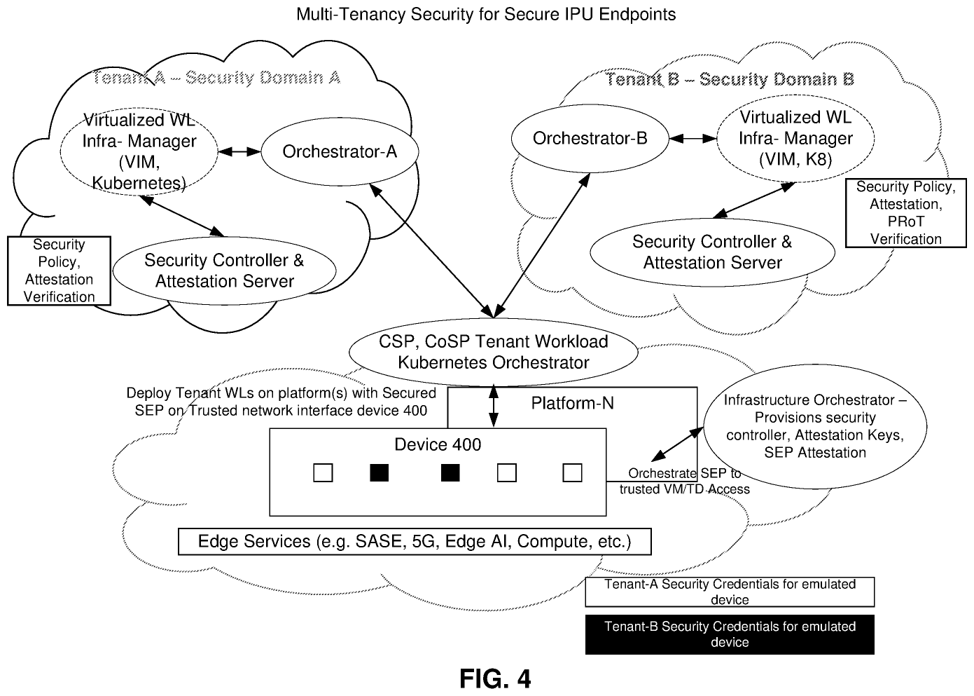

FIG. 4 depicts an example of end-to-end tenant attestation of an emulated SEP device in a trust domain (TD). Device 400 can be deployed in one or more of CSP, CoSP, Edge, Edge artificial intelligence (AI), 5 G, secure access service edge (SASE), mobile edge computing (MEC) deployment. For example, for a tenant (e.g., Tenant A or Tenant B), an orchestrator (e.g., Kubernetes, Docker, OpenStack, Apache Mesos, and so forth) can manage emulated SEP device creation, attestation, and assignment to trusted applications (e.g., TDX, AMD-SEV, or others) as well as verification of platform root of trust (PRoT). In some examples, orchestrator can cause particular emulated SEP devices to be assigned to Tenant A and cause other particular emulated SEP devices to be assigned to Tenant B.

An infrastructure orchestrator can provision security controller of device 500 with attestation keys and perform attestation of endpoint circuitry. A per-tenant orchestrator can perform attestation of identifiers and compositions of software, firmware, and hardware of emulated SEP devices. In some examples, a per-tenant orchestrator can allocate attestation keys to a security controller for the security controller to perform attestation of compositions of software, firmware, and hardware of emulated SEP devices. Attestation can provide a trust establishment mechanism that enables a tenant to ascertain the properties of the destination system for the system's ability to offer the different levels of security guarantees that the tenant requires to run their trusted workloads. In some examples, trusted firmware executed by a SEP or trusted hardware can create unique identifiers for an emulated SEP device. An attestation key (e.g., attestation root key) can be used by a security controller to sign a hash value obtained by concatenating a first boot firmware and subsequent firmware and/or software images that are in a Trusted Compute Base (TCB) of the emulated SEP devices. The security controller can send an attestation quote to the CSP or CoSP trusted attestation server to verify the signed quote to authenticate or attest an emulated SEP device or indicate the signed quote is not verified and therefore indicate the emulated SEP device is not authenticated or attested. The emulated devices can be assigned to a TD for tenant A or a TD for tenant B.

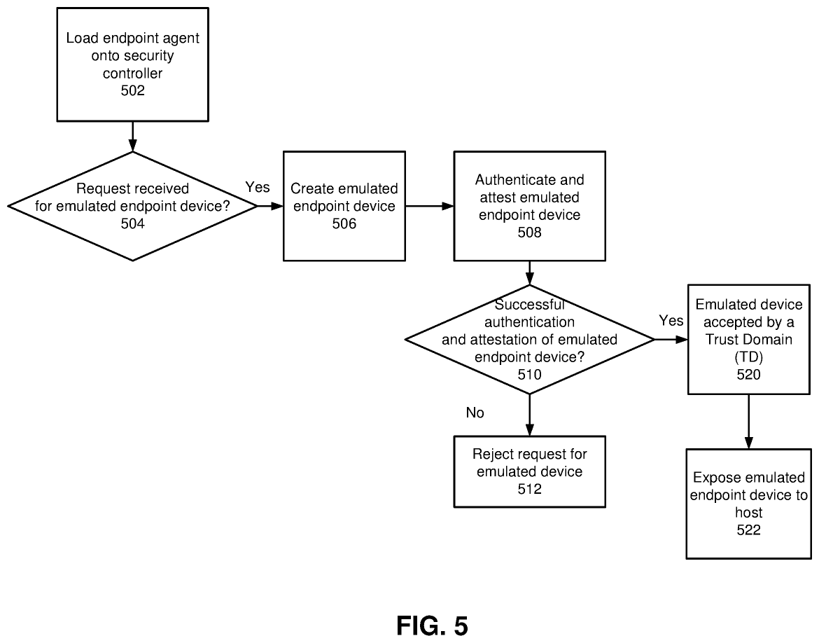

FIG. 5 depicts an example process to assign an emulated device. The process can be performed by a security controller or other trusted software, firmware, or circuitry. At 502, a SEP agent can be loaded for execution by a security controller. At 504, a determination can be made as to whether a request for access to an emulated SEP device instance was received from a requester such as an application. If a request for access to an emulated SEP device instance was received, the process can proceed to 506. If a request for access to an emulated SEP device instance was not received, the process can return to 504.

At 506, an emulated SEP device instance can be created. For example, an emulated SEP device instance can correspond to a virtio device instance. In some examples, at 506, the SEP agent can determine whether an emulated SEP device instance is available. For example, an emulated SEP device instance can be available if a unique identifier is assigned to the emulated SEP device, composite software and/or hardware resources allocated to the emulated SEP device have been authenticated and attested, and the emulated SEP device instances is assigned to a trust domain. In some examples, based on restart or migration of an emulated device, the emulated device can be reassigned for use. Based on an available emulated SEP device, the process can proceed to 522 (not shown).

At 508, a device fingerprinting process can be performed to create an emulated SEP device with a specific configuration. The SEP agent can perform secure onboarding of an emulated device (e.g., virtio, Data Plane Development Kit (DPDK), Vector Packet Processing (VPP), etc.)) Device fingerprinting can involve authentication and attestation of composite software and/or hardware resources allocated to the emulated SEP device and assignment of a unique identifier of the emulated SEP device. At 510, a determination can be made as to whether the emulated SEP device fingerprinting occurred successfully. Based on successful attestation of the emulated SEP device, the process can proceed to 520. Based on unsuccessful attestation of the emulated SEP device, the process can proceed to 512. If the SEP device fingerprint fails, the SEP create new virtio device instance fails and an SEP new virtio device instance is not exposed to the host and an error is logged. At 512, the request for an emulated SEP device is rejected and the process returns to 504. An emulated SEP device is not exposed to the host until the device fingerprint has occurred successfully.

At 520, if the SEP device fingerprint passes for an emulated SEP device, the emulated device can be assigned successfully to a trust domain (TD). For example, the emulated device can be assigned successfully to a TD of a tenant. At 522, the emulated device can be exposed to the host, which can be accessed by an application (e.g., VM or container).

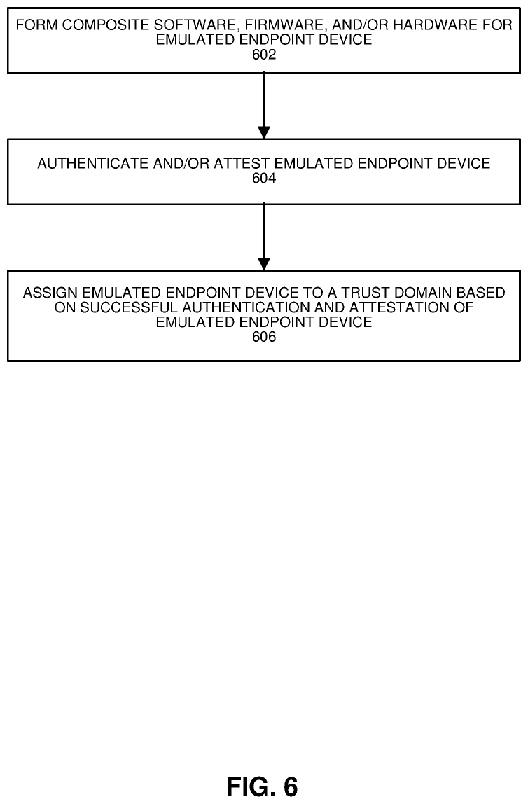

FIG. 6 depicts an example process. The process can be performed by a security controller of endpoint circuitry (e.g., accelerator or SEP) connected inline between a host system and a device, in some examples. At 602, a composition of software, firmware, and/or hardware can be assigned to an emulated endpoint device. At 604, authentication and attestation of the composition of software, firmware, and/or hardware assigned to the emulated endpoint device can occur. At 606, based on authentication and attestation of the composition of software, firmware, and/or hardware assigned to the emulated endpoint device, the emulated endpoint device can be made available for access to a trust domain. A trust domain can utilize a trusted VM, trusted container, and/or a trusted process.

FIG. 7 depicts an example computing system. Components of system 700 can be configured to provide emulated endpoint devices that are attested and executing trusted computing environments, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. In some examples, graphics interface 740 generates a display based on data stored in memory 730 or based on operations executed by processor 710 or both. In some examples, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes cryptographic circuitry 721, memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710. Cryptographic circuitry 721 can encrypt data prior to storage in memory 730 or decrypt data after access from memory 730, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Network interface 750 (e.g., NIC) can include one or more of: a network interface controller (NIC), a remote direct memory access (RDMA)-enabled NIC, SmartNIC, router, switch, or network-attached appliance. Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. For example, one or more programmable pipelines or fixed function processors or other circuitry can be configured to perform event processing using an accelerator or other circuitry in line with network interface device 750 at least where network interface device 750 is accessed using device virtualization, as described herein.

For example, network interface 750 can include Media Access Control (MAC) circuitry, a reconciliation sublayer circuitry, and physical layer interface (PHY) circuitry. The PHY circuitry can include a physical medium attachment (PMA) sublayer circuitry, Physical Medium Dependent (PMD) circuitry, a forward error correction (FEC) circuitry, and a physical coding sublayer (PCS) circuitry. In some examples, the PHY can provide an interface that includes or use a serializer de-serializer (SerDes). In some examples, at least where network interface 750 is a router or switch, the router or switch can include interface circuitry that includes a SerDes.

In some examples, system 700 includes storage subsystem 780 to store data in a nonvolatile manner. In some examples, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. A volatile memory is memory whose state (and therefore the data stored in it) is indeterminate if power is interrupted to the device. A non-volatile memory (NVM) device is a memory whose state is determinate even if power is interrupted to the device. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In some examples, storage subsystem 780 includes controller 782 to interface with storage 784. In some examples controller 782 is a physical part of interface 714 or processor 710 or can include circuits or logic in both processor 710 and interface 714.

In an example, system 700 can be implemented using interconnected compute systems of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4 G), 3GPP 5 G, and variations thereof. Data can be copied or stored to virtualized storage nodes or accessed using a protocol such as Non-Volatile Memory Express over Fabrics (NVMe-oF) (e.g., NVMe-oF specification, version 1.0 (2016) as well as variations, extensions, and derivatives thereof) or NVMe (e.g., Non-Volatile Memory Express (NVMe) Specification, revision 1.3c, published on May 24, 2018 (“NVMe specification”) as well as variations, extensions, and derivatives thereof).

Various examples of device virtualization techniques are described next. Single Root I/O Virtualization (SR-IOV) and Sharing specification, version 1.1, published Jan. 20, 2010 by the Peripheral Component Interconnect (PCI) Special Interest Group (PCI-SIG) provides hardware-assisted high performance I/O virtualization technique that provides for scalable sharing across virtualized execution environments of I/O devices, such as network interface devices, storage controllers, packet processor, packet processing pipeline, cryptographic accelerator (e.g., decryption or encryption), memory pool controllers, graphics processing units, and other hardware accelerators across a large number of virtualized execution environments. PCI Express (PCIe) is defined by PCI Express Base Specification, revision 4.0, version 1.0, published Oct. 5, 2017. Unlike the coarse-grained device partitioning approach of SR-IOV to create multiple VFs on a PF, S-IOV enables software to flexibly compose virtual devices utilizing the hardware-assists for device sharing at finer granularity. Some operations on the composed virtual device are performed by the underlying device hardware, while some operations can be emulated through device-specific composition software executed by the host. A technical specification for Scalable Input/Output (I/O) Virtualization (S-IOV) is Intel® Scalable I/O Virtualization Technical Specification (June 2018), and revisions and variations thereof.

Communications between devices can take place using a network that provides die-to-die communications; chip-to-chip communications; circuit board-to-circuit board communications; and/or package-to-package communications. One or more components of system 700 can be implemented as part of a system-on-chip (SoC).

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3 G, 4 G, 5 G and so forth), macro base station (e.g., 5 G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

FIG. 8 depicts an example network interface device. Network interface device 800 can manage performance of one or more processes using one or more of processors 806, processors 810, accelerators 820, memory pool 830, or servers 840-0 to 840-N, where N is an integer of 1 or more. Network interface device 800 can provide emulated endpoint devices of endpoint circuitry 808, that are attested and executing trusted computing environments, as described herein. In some examples, processors 806 of network interface device 800 can execute one or more processes, applications, VMs, containers, microservices, and so forth that request performance of workloads by one or more of: processors 810, accelerators 820, memory pool 830, and/or servers 840-0 to 840-N. Network interface device 800 can utilize network interface 802 or one or more device interfaces to communicate with processors 810, accelerators 820, memory pool 830, and/or servers 840-0 to 840-N. Network interface device 800 can utilize programmable pipeline 804 to process packets that are to be transmitted from network interface 802 or packets received from network interface 802.

Programmable pipeline 804 and/or processors 806 can be configured or programmed using languages based on one or more of: P4, Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes a system interface and a device that includes: circuitry configured to: based on attestation of the device, assignment of an emulated device to a trust domain (TD), and attestation of a device configuration associated with the emulated device, provide trusted and secure access to the emulated device to a virtual execution environment, wherein: the device configuration is associated with one or more circuitry and software associated with the device, the emulated device is accessible via a device interface to the virtual execution environment, and the device configuration comprises one or more of: register access, a network interface device, a storage controller, an accelerator, processor, or a memory device.

Example 2 includes one or more examples, wherein the circuitry is to perform attestation and signing of an emulated device key and provide data based on the emulated device key for communications between the virtual execution environment and the emulated device.

Example 3 includes one or more examples, wherein the circuitry is to provide a secure and trusted environment to perform: emulated device key generation, provisioning and/or generation of an attestation key, and signing of the emulated device key and the attestation key.

Example 4 includes one or more examples, wherein the circuitry is to execute trusted device firmware to: generate an attested quote based on one or more of: identifiers of the one or more circuitry and software associated with the device, first bootable device firmware, executable device firmware, device configuration, endpoint emulated device firmware, or endpoint emulated device configuration and assignments and verify the attested quote prior to provide trusted access to the emulated device to a virtual execution environment.

Example 5 includes one or more examples, and includes a memory device, wherein the circuitry is to cause the memory device to: store code, data, and context state for the emulated device in the TD associated with a tenant so that the code, data, and context state continue to be stored based on the TD associated with the tenant going offline and resuming emulated device state based on attestation of the emulated device and scheduling the TD and the attested emulated device for use.

Example 6 includes one or more examples, wherein the device interface is consistent with one or more of: Peripheral Component Interconnect express (PCIe), Compute Express Link (CXL), Universal Chiplet Interconnect Express (UCIe), Single Root I/O Virtualization (SR-IOV), or Scalable Input/Output (I/O) Virtualization (S-IOV).

Example 7 includes one or more examples, wherein the device comprises one or more of: the network interface device, the storage controller, the accelerator, the processor, or the memory device.

Example 8 includes one or more examples, wherein the emulated device comprises endpoint circuitry.

Example 9 includes one or more examples, wherein the virtual execution environment comprises one or more of: virtual machine, container, application, process, service, or micro-service.

Example 10 includes one or more examples, and includes a server, wherein the server communicatively coupled to the system interface and wherein the server is to execute the virtual execution environment to access the emulated device.

Example 11 includes one or more examples, and includes a method comprising: based on attestation of a platform, assignment of an emulated device to a trust domain (TD), and attestation of a device configuration associated with the emulated device, and register access locking, a controller providing trusted access to the emulated device to a virtual execution environment, wherein: the device configuration comprises one or more of: register access, a network interface device, a storage controller, an accelerator, processor, or a memory device.

Example 12 includes one or more examples, and includes the controller performing attestation and signing of an emulated device key and providing the emulated device key for communications between the virtual execution environment and the emulated device

Example 13 includes one or more examples, and includes the controller: generating an attested quote based on one or more of: identifiers of one or more circuitry and software associated with the device, first bootable device firmware, executable device firmware, device configuration, endpoint emulated device firmware, or endpoint emulated device configuration and assignments and verifying the attested quote prior to provide trusted access to the emulated device to a virtual execution environment.

Example 14 includes one or more examples, and includes the controller: storing emulated device state for the emulated device in the TD associated with a tenant, wherein the emulated device state continue to be stored based on the TD associated with the tenant going offline and the emulated device state is accessible to the emulated device after the TD and the emulated device is re-scheduled for use.

Example 15 includes one or more examples, wherein the emulated device comprises endpoint circuitry.

Example 16 includes one or more examples, wherein the controller is attested at manufacture.

Example 17 includes one or more examples, and includes at least one non-transitory computer-readable medium comprising instructions stored thereon, that if executed by one or more circuitry, cause the one or more circuitry to: based on attestation of a platform, assignment of an emulated device to a trust domain (TD), and attestation of a device configuration associated with the emulated device, and register access locking, a controller providing trusted access to the emulated device to a virtual execution environment, wherein the emulated device comprises endpoint circuitry.

Example 18 includes one or more examples, wherein the device configuration comprises one or more of: register access, a network interface device, a storage controller, an accelerator, processor, or a memory device.

Example 19 includes one or more examples, and includes instructions stored thereon, that if executed by one or more circuitry, cause the one or more circuitry to: perform attestation and sign of an emulated device key and provide the emulated device key for communications between the virtual execution environment and the emulated device

Example 20 includes one or more examples, and includes instructions stored thereon, that if executed by one or more circuitry, cause the one or more circuitry to: generate an attested quote based on one or more of: identifiers of the one or more circuitry and software associated with the device, first bootable device firmware, executable device firmware, device configuration, endpoint emulated device firmware, or endpoint emulated device configuration and assignments and verify the attested quote prior to provide trusted access to the emulated device to a virtual execution environment.

What is claimed is:

1. An apparatus comprising:
a system interface and
a device comprising:
circuitry configured to:
based on attestation of the device, assignment of an emulated device to a trust domain (TD), and attestation of a device configuration associated with the emulated device, provide trusted and secure access to the emulated device to a virtual execution environment, wherein:
the device configuration is associated with one or more circuitry and software associated with the device,
the emulated device is accessible via a device interface to the virtual execution environment, and
the device configuration comprises one or more of: register access, a network interface device, a storage controller, an accelerator, processor, or a memory device.

2. The apparatus of claim 1, wherein the circuitry is to perform attestation and signing of an emulated device key and provide data based on the emulated device key for communications between the virtual execution environment and the emulated device.

3. The apparatus of claim 1, wherein the circuitry is to provide a secure and trusted environment to perform: emulated device key generation, provisioning and/or generation of an attestation key, and signing of the emulated device key and the attestation key.

4. The apparatus of claim 1, wherein the circuitry is to execute trusted device firmware to:
generate an attested quote based on one or more of: identifiers of the one or more circuitry and software associated with the device, first bootable device firmware, executable device firmware, device configuration, endpoint emulated device firmware, or endpoint emulated device configuration and assignments and
verify the attested quote prior to provide trusted access to the emulated device to a virtual execution environment.

5. The apparatus of claim 1, comprising a memory device, wherein the circuitry is to cause the memory device to:
store code, data, and context state for the emulated device in the TD associated with a tenant so that the code, data, and context state continue to be stored based on the TD associated with the tenant going offline and resuming emulated device state based on attestation of the emulated device and scheduling the TD and the attested emulated device for use.

6. The apparatus of claim 1, wherein the device interface is consistent with one or more of: Peripheral Component Interconnect express (PCIe), Compute Express Link (CXL), Universal Chiplet Interconnect Express (UCIe), Single Root I/O Virtualization (SR-IOV), or Scalable Input/Output (I/O) Virtualization (S-IOV).

7. The apparatus of claim 1, wherein the device comprises one or more of: the network interface device, the storage controller, the accelerator, the processor, or the memory device.

8. The apparatus of claim 1, wherein the emulated device comprises endpoint circuitry.

9. The apparatus of claim 1, wherein the virtual execution environment comprises one or more of: virtual machine, container, application, process, service, or micro-service.

10. The apparatus of claim 1, comprising a server, wherein the server communicatively coupled to the system interface and wherein the server is to execute the virtual execution environment to access the emulated device.

11. A method comprising:
based on attestation of a platform, assignment of an emulated device to a trust domain (TD), and attestation of a device configuration associated with the emulated device, and register access locking, a controller providing trusted access to the emulated device to a virtual execution environment, wherein:
the device configuration comprises one or more of: register access, a network interface device, a storage controller, an accelerator, processor, or a memory device.

12. The method of claim 11, comprising:
the controller performing attestation and signing of an emulated device key and providing the emulated device key for communications between the virtual execution environment and the emulated device

13. The method of claim 11, comprising the controller:
generating an attested quote based on one or more of: identifiers of one or more circuitry and software associated with the device, first bootable device firmware, executable device firmware, device configuration, endpoint emulated device firmware, or endpoint emulated device configuration and assignments and
verifying the attested quote prior to provide trusted access to the emulated device to a virtual execution environment.

14. The method of claim 11, comprising the controller:
storing emulated device state for the emulated device in the TD associated with a tenant, wherein the emulated device state continue to be stored based on the TD associated with the tenant going offline and the emulated device state is accessible to the emulated device after the TD and the emulated device is re-scheduled for use.

15. The method of claim 11, wherein the emulated device comprises endpoint circuitry.

16. The method of claim 11, wherein the controller is attested at manufacture.

17. At least one non-transitory computer-readable medium comprising instructions stored thereon, that if executed by one or more circuitry, cause the one or more circuitry to:
based on attestation of a platform, assignment of an emulated device to a trust domain (TD), and attestation of a device configuration associated with the emulated device, and register access locking, a controller providing trusted access to the emulated device to a virtual execution environment, wherein the emulated device comprises endpoint circuitry.

18. The computer-readable medium of claim 17, wherein the device configuration comprises one or more of: register access, a network interface device, a storage controller, an accelerator, processor, or a memory device.

19. The computer-readable medium of claim 17, comprising stored instructions thereon, that if executed by one or more circuitry, cause the one or more circuitry to:
perform attestation and sign of an emulated device key and provide the emulated device key for communications between the virtual execution environment and the emulated device

20. The computer-readable medium of claim 17, comprising stored instructions thereon, that if executed by one or more circuitry, cause the one or more circuitry to:
generate an attested quote based on one or more of: identifiers of the one or more circuitry and software associated with the device, first bootable device firmware, executable device firmware, device configuration, endpoint emulated device firmware, or endpoint emulated device configuration and assignments and
verify the attested quote prior to provide trusted access to the emulated device to a virtual execution environment.
